(19) United States
(12) Patent Application Publication
(10) Pub. No.: US 2008/0087580 A1
(43) Pub. Date: Apr. 17, 2008

(54) Fine particle precious metal and liquid mercury recovery system and method using multi-layer filter with under-air flow

(76) Inventor: Ronald K. Coen, Corpus Christi, TX (US)

Correspondence Address: Donald W. Meeker;Patent Agent, 924 East Ocean Front #E, Newport Beach, CA, 92661, US

(21) Appl. No.: 11/581,403

(22) Filed: Oct. 17, 2006

(51) Int. Cl. B07B 1/28; B07B 7/06

(52) U.S. Cl. 209/312

(57) ABSTRACT

A multi-layer filter of cotton, plastic mesh and burlap with top and bottom metal mesh is sandwiched between two sections of wooden frame and mounted on a wind chamber. An even non-deflected steady stream of air under the filter produces an electro dynamic charge in the filter to attract fine particles of gold, silver, platinum, or mercury to the filter from a steady stream of earth material, containing fine particles, flowing over the downwardly angled filter.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to fine gold recovery and particularly to a fine gold and precious metals extractor comprising a multi-layer filter inside a frame at an angle to the ground with a blower, such as a leaf blower underneath and a box above the screen with a release gate so that the blower, which is a non-deflected steady air stream fan or blower, is turned on and blows at 150 cubic feet per minute (cfm) through a baffle under the filter to distribute the steady flow of air under and up through the entire surface of the filter; the gravel or sand or other dry mixture of earth material containing small and faint tiny traces of gold is released from the box through the gate and flows down over the filter, the large unwanted particles of earth material flow down into a container or onto the ground and the fine gold or precious metal particles are attracted downwardly onto the filter by dynamic charge.

2. Description of Related Art Including Information Disclosed Under 37 CFR 1.97 and 1.98

Trapping gold, silver and platinum are among the rarest metals on earth. They occur naturally as the reduced metal (Au.degree.) or associated with quartz or pyrites as telluride (AuTe.sub.2), petzite (AuAg).sub.2 Te or sylvanite (AuAg)Te.sub.2. Most frequently gold, silver and platinum are dispersed in low concentration throughout large volumes of material. Gold, silver, and platinum deposits occur in belts across the earth's crust in various forms: placers or aluminum quartz veins in sedimentary or indigenous formation, blanket or pebble beds or conglomerates, or as base metal ore associations. These ore are bearing veins are found in rocks of all compositions and geologic ages, deposited in cavities and associated with rocks such as slates or schists.

The demand for gold is causing the rapid depletion of worldwide reserves. It has been estimated that most high-grade ore reserves will be depleted within the next 10-50 years. Another problem for the United States is that many strategic metals, including gold, are vulnerable to embargoes. It would be very desirable for the U.S. to increase its domestic gold reserves by mining available low-grade ores. Furthermore, much of the gold mined in the U.S. is exported to Korea and Japan for refining, processing and finishing. This is an undesirable balance of trade: like an underdeveloped country, the U.S. is exporting raw material resources and importing finished goods and gold ready for industrial applications. As a result, the United States consumes more gold than it produces. One of the reasons it is expensive to mine and refine gold in the U.S. is the cost of environmental protection. As will be explained below, the present invention solves all of these problems.

There are basically four types of gold deposits: placer deposits, lode deposits, blanket (or reef-type) deposits and disseminated deposits.

Placer deposits are flat-laying deposits composed of unconsolidated materials, such as gravel and sands, in which the gold particles occur as free particles ranging in size from nuggets to fine flakes. They are the result of erosion and transport of rock. Placer deposits most commonly are mined using water based surface methods, including hydraulicking, dredging and open pit mining. These deposits usually are not mined in underground operations.

Lode deposits, by contrast consist of gold particles contained in quartz veins or country rock. Lode deposits usually are mined in deep underground mines using a variety of methods, although sometimes lode deposits are surface mined.

The blanket or reef-type deposits are deposits in which the gold exists in quartz conglomerates. Such deposits have resulted from the consolidation of placer deposits. These types of deposits are mined exclusively using underground mining techniques.

Disseminated gold deposits have three identifying characteristics. The gold mineralization is fairly evenly distributed throughout the deposit rather than being concentrated in veins (as in lode deposits) or in pay-streaks (as in placer deposits); the deposits consist of in place materials rather than transported materials; and the disseminated deposits are less flat. Generally, these types of deposits are mined using surface mining techniques.

Nearly all of the world's gold production has come from mining reef-type or placer type deposits in the past. The Witwaterstrand and Orange Free State deposits in the Republic of Africa, the richest gold deposits in the world, are reef-type deposits. The mining in the United States and Australia by comparison, is now predominantly mining disseminated deposits. This type of gold mining is a relatively recent development, having begun in 1965. An estimated 75% of the recoverable gold in the United States is composed of surface mine-able material and an estimated 25% of the recoverable Australian gold is surface mine able. By contrast, the greatest percentages of gold in the Republic of South Africa and Canada are contained in deep deposits which must be mined in large, underground operations.

At present, there are fundamentally six possible treatment methods for “refractory” ores, although not all of them are useful for treating carbon problems. Roasting and chlorination are the two methods that are most developed and applicable for treating carbon-bearing ores. The others may play some role in the future or are often confused with methods for processing carbonaceous ores even within the mining industry.

1. Roasting. This is the method used in all of the most recent pretreatment plants. In Nevada four roasters have been put into operation since 1986, and at least one more in the planning stage. Modem roasters use a fluidized bed construction and conventional fuel sources to heat the ores to about 700 degrees. The roasted ore is then quenched after being separated from dust and off-gasses. Following quenching, the oxidized ore can be processed using traditional cyanide/activated carbon extraction methods. For any particular ore composition, these plants operate in a narrow range of tolerances. Below optimum temperature the carbon in the ore remains actively “preg robbing”. Above the optimum, the rock becomes increasingly less porous and cannot be cyanided successfully in later stages to remove the gold from it. As a result, roaster efficiency in an operating environment tends to vary widely with variation in the feed ore. Roaster costs are driven in large part by two factors: energy economics and environmental regulation. Energy sources are used for both heating and process control such as oxygen injection. As a result, this method is particularly sensitive to fluctuations in fuel prices. Environmental regulation is also a large and growing cost factor in the operation of roasters. The off-gas must be passed through an electrostatic precipitator to remove dust, and then scrubbed to remove extremely toxic mercury and arsenic compounds and sulfur dioxide. As emission standards become stricter, process costs increase dramatically. Almost without exception, both analytical studies and actual operators estimate the cost of roasting to be in the area of $25 per ton of ore, although one source claims an estimate for a proposed plant of $8 per ton.

2. Chlorination. This was the method most favored until process economics and environmental regulation tipped the decision in favor of roasting. At least two chlorination plants were operating recently, although one of them may already be off-line. In this process, the ore is ground and mixed with water to form a slurry. Chlorine gas is pumped into the slurry under pressure at a rate of about 60 to 120 lbs/ton, depending on residence time, organic carbon concentration in the ore and percent solids in the slurry. The chlorine gas will oxidize the carbon in the ore, rendering it less “preg robbing.” After treatment, the hypochlorous acid generated must be treated with a reducing agent to prevent it from destroying the cyanide used later in the process. This process is particularly sensitive to the amount of sulfide in the ore, since sulfur is oxidized before carbon. Higher sulfide ores require much more chlorine gas. Environmental factors also play a large part in driving costs. Gas emissions from the tanks must be captured by alkaline scrubbers before being released to remove the 10% chlorine they contain. High-pressure chlorine gas is extremely dangerous. Finally, the process is difficult to control in operation, and plants suffer from the corrosive gas. As a result of all of these factors, roasting will be the economically favored alternative for the foreseeable future.

3. Elextrooxidation. This technique is a variant of chlorination in which salt is added to the slurry and is then decomposed electrolytically to produce sodium and chlorine gas. The chlorine is then used in the same manner as in (2) above. However, unless there is a radical decrease in energy costs, this method will remain. Even less economically attractive than chlorination.

4. Pressure autoclaving. This method is far more successful at destroying sulfidic materials that make the ore refractory than it is at destroying preg robbing carbon that may be present. It is mentioned here for the sake of completeness.

5. Blanking Agents. There has been some experimentation with a proprietary blanking agent described in the literature. While no details of its composition or mode of action have been given, the name suggests that it acts by masking the active carbon sites so that they do not bind gold cyanide complex. In the past, kerosene has been tried as a blanking agent with poor results. Research results reported do not raise recovery to economic levels for blanking, and the researchers continue to search for a more effective treatment.

6. Oxidation with Base Metals. A chemical method of oxidizing carbon using base metals and chemical oxidants has been issued a patent. It does not appear to be an economical alternative in practice, and has not been adopted by any of the major mining companies.

A typical roasting and cyanidation plant operates as follows. The ore is first ground to a fine dust, concentrated to remove unproductive rock volume, roasted and quenched (carbon deactivation), slurried with water to about 50% solids and then treated with cyanide. Finally, the gold cyanide is adsorbed on activated carbon. While this is a logical order for these processes, an important point to note is that carbon deactivation does not need to precede cyanidation. The carbon interferes with removal of gold cyanide complex from process slurries, not dissolving of the gold.

The process begins with the same grinding and concentrating steps as roasting. Following concentration, the ore is combined with a living biological agent in an aqueous slurry at a concentration of 0.01% biomass. The slurry is then treated with cyanide. The biological agent has an affinity for the gold cyanide complex several orders of magnitude greater than the native carbon. As a result, it will interfere with and nearly totally outcompete the “preg robbing” (carbon binding) qualities of the ore itself.

The next step in the process will be recovery of the biomass-gold complex from the slurry by flotation. The agent can be dried to a tiny fraction of the initial ore weight (ca 0.4 lbs/ton of ore), and will contain ca. 1-2% gold. This concentration level is well within the parameters of biological heavy metal recovery reported in the literature. Finally, the dried biomass will be ashed and the gold recovered.

In addition to the surface mine-able gold, there are large bodies of gold ore currently which are not mine-able in the United States because of problems with the current technology.

Methods for recovering gold from its ores (termed “beneficiation methods”) are extremely expensive and labor and heavy machinery intensive. Gold, silver and platinum are the least reactive metals on earth. They do not combine with oxygen or with nearly any other chemicals, no matter how corrosive. Gold, silver and platinum combine with cyanide, however, and all of the commonly used industrial methods for removing these ores from the earth require the use of cyanide which is highly toxic, hazardous to the environment and difficult to remove. Basically, the first step in all methods is to subject the ore to cyanide leaching followed by a gold recovery process.

The most common methods for treating and destroying residual cyanide from heap leaching involve chemical treatments, including for example, alkali chlorination or other means of oxidizing cyanide to its intermediate or end constituents. These methods produce unstable cyanide complexes that gradually break down to produce residual free cyanide. For these reasons, the methods are inadequate from an environmental impact standpoint.

U.S. Pat. No. 3,773,174, issued Nov. 20, 1973 to Stimpel, concerns an electrostatic ore processor for separation of metal values from sand and pulverized matter such as found in ores and the like in which a tray has a core with a series of compound openings to admit pressurized air therethrough from an air supply source. Multiple layers of air permeable fabric overly the core on the side thereof opposite from the air input, and transverse rods extend across the layers of fabric at spaced intervals. Air passing through the core and fabric results in agitation of ore placed on the tray and results further in the creation of an electrostatic charge on the cloth which serves to attract metal values.

U.S. Pat. No. 4,615,797, issued Oct. 7, 1986 to Keene, relates a dry washer with hot air supply. The electrostatic recovery of gold in the dry washer is improved by providing means to scavenge the waste heat from the internal combustion engine that powers the air blower. This preheats the intake air to the air blower, whereby the equilibrium temperature of the compressed air delivered to the partially fluidized bed of ore particles on the riffle table is raised about 50.degree. F. above ambient temperature. The layer of fabric underlying the bed of particles is maintained at bone dryness, the ore particles are dried, and the electrostatic forces operate under most favorable conditions at low relative humidity.

U.S. Pat. No. 300,042, issued Jun. 10, 1884 to Card, shows a dry ore separator in which an inclined ore bed having riffles to impede the passage of the precious metal and a continuous air-current to assist in removal of lighter and unwanted particles.

U.S. Pat. No. 2,116,613, issued May 10, 1938 to Bedford shows a gravity electrostatic separation process which uses an electrode to charge the material to be separated. The material falls from a hopper to a permeable dielectric and a wire screen below. Agitation is effected by a current of air from below the wire screen. U.S. Pat. No. 234,565, issued Nov. 16, 1880 to Hall, provides a portable machine for separating precious metals from their ores. The machine comprises frame which holds a casing having an air inlet and an air outlet for the purpose of extraction using a pressurized blast of air combined with suitable chemicals.

U.S. Pat. No. 244,114, issued Jul. 12, 1881 to Soulages, claims a system for separating heavy ore components from lighter ones by directing a draft of air across a flowing stream of ore. The heavier components fall into a first hopper and the lighter particles fall into succeeding hoppers.

U.S. Pat. No. 317,192, issued May 5, 1885 to Porter, claims an ore separator comprising a fan, a fan-casing having an air passage covered by a sieve which traps precious metal particles and a hopper above the fan casing and the sieve.

U.S. Pat. No. 443,901, issued Dec. 30, 1890 to Craig, shows an apparatus for separating gold and silver from ores by subjecting the mixture to a column of horizontally moving air so that the particles are blown into separate bins each according to its own weight and specific gravity.

U.S. Pat. No. 775,965, issued Nov. 29, 1904 to Edison, discloses a dry separator in which a blower produces a flow of air through a large passage. The passage defines an upper aperture through which a quantity of to-be-separated material is introduced to the air flow. The bottom portion of the air passage includes a pair of collecting baffles spaced apart with one upstream of the other in the air flow. In operation, a granular material such as a mixture of free gold and loose gravel is dropped through the air flow and the heavier gold material accumulates in the upstream baffle while the lighter gravel accumulates in the downstream baffle.

U.S. Pat. No. 853,917, issued May 14, 1907 to Clifford, concerns an ore separating and concentrating machine which uses air currents that are drawn across corrugated shaker plates to bring the lighter particles or ore to the top while the heavier precious metal particles fall to the bottom towards the discharge portions of the corrugated plates.

U.S. Pat. 877,411, issued Jan. 21, 1908 to Custer, illustrates an ore separator comprising a frame, a plurality of flumes horizontally mounted on the frame, screens extending down in the upper flumes, air blast mechanisms communicating with the flumes, a feeding mechanism communicating with the flumes, and a jigging mechanism acting on said feeding mechanism.

U.S. Pat. No. 2,101,295, issued Dec. 7, 1937 to Rusk, provides an apparatus for air floatation separation in which an upwardly directed draft of air is employed to hold sand in suspension while heavier minerals or particles settle out.

U.S. Pat. No. 2,160,822, issued Jun. 6, 1939 to Bigelow, shows a device for the dry separation of precious metals from finely divided material. The separator has electrically charge plates which aid in the separation of the relatively light precious metals from the finely divided material. An air flotation process is provided to suspend the particles of precious metals, such as fine gold, and allow them to be removed electrostatically from such suspension.

U.S. Pat. No. 6,682,005, issued Jan. 27, 2004 to Kantonen, indicates a method of recovery of precious metals & heavy minerals, in which raw material containing precious metals and heavy minerals is introduced into a comminuting chamber. The raw material falls onto rotating chains which drive the material against the side wall of the chamber with sufficient velocity to cause the raw material to fracture. Air flows upwardly at the side wall and classifies the particles into a first fraction which falls to the floor of the chamber and a second fraction which is carried upward to a trommel. Large particles from the trommel are recycled to the chamber while fines are discarded as tailings. The rate of upward flow of air in the chamber, the rate of rotation of the chains and the size of particles separated by the trommel are all adjusted in order to ensure that the particles that collect on the floor of the chamber are rich in precious metals and heavy minerals.

U.S. Pat. No. 4,673,492, issued Jun. 16, 1987 to Jasinski, puts forth an apparatus for recovering gold from gold-containing mixtures by forming a gaseous effluent of said mixture and bringing it into contact with baffles which are arcuately disposed in series so as to divert the gold onto collecting trays. The trays are disposed within a chamber in such manner as to create pathways for the effluent so that divergent streams of said effluent are directed to the baffles to enhance the recovery operation.

U.S. Pat. No. 1,918,343, issued Jul. 18, 1933 to Lightfoot, illustrates a dry concentrator for separating fine gold particles from other material. The dry concentrator comprises a supporting frame structure, an inclined vibrating chute, and a fan for producing air to agitate the material so that the heavier gold particles fall to the bottom of the chute where they may be collected.

What is needed is a layered filter with a non-deflected steady stream of air from below to recover fine visible amounts of gold, silver, and platinum with a fast easy recovery while aiding the environment by obviating the need for harmful liquid mercury for recovery in a novel method for mining gold silver and platinum along with mercury extraction for purification on which, unlike the methods used to date, the methods do not pollute the air or water and are environmentally sound and safe.

### BRIEF SUMMARY OF THE INVENTION

An object of the present invention is to provide a layered filter with a non-deflected steady stream of air from below to recover fine visible amounts of gold, silver, and platinum with a fast easy recovery while aiding the environment by obviating the need for harmful liquid mercury for recovery.

Another related object of the present invention is to introduce novel methods for mining gold silver and platinum along with mercury extraction for purification on which, unlike the methods used to date, the methods do not pollute the air or water and are environmentally sound and safe.

A further object of the present invention is to increase gold, silver, and platinum, production and the available domestic gold, silver and platinum reserves by both improving the economics of existing operations and making cost-effective the recovery of certain types of low grade material and generally surface mine-able material prevalent in the United States.

In brief, the present invention provides a multi-layer filter inside a frame at an angle to the ground with a blower, such as a leaf blower underneath and a box above the screen with a release gate so that the blower, which is a non-deflected steady air stream fan or blower, is turned on and blows at 150 cubic feet per minute (cfm) through a baffle under the filter to distribute the steady flow of air under and up through the entire surface of the filter. Then the gravel or sand or other dry mixture of earth material containing small and faint tiny traces of gold and/or silver and/or platinum is released from the box through the gate and flows down over the filter. The large particles of earth material flow down into a container or just onto the ground if that is where the material originated.

Small and tiny particles of gold (and platinum and silver) are attracted downward onto the filter by dynamic charge. The particles of gold, platinum, and silver each have an extra negative charged molecule. The four layers of material (cotton, burlap, felt, and plastic mesh) sandwiched between two metal ⅛ inch grid screens with the wind blowing through it creates a positive charge on the multi-layer filter which attracts the negatively charged small and tiny particles of the precious metals down onto the filter even against the wind. At least 95% of all the precious metal particles are removed with a single pass over the filter.

After all the material is collected (or precipitated) on the multi-layer filter, a gold panning process is usually performed to separate the fine gold from the other material. That is now commonly done and is not part of this invention. The most significant unique factors are the four layers of material in the filter (cotton, burlap, felt, plastic mesh) and the fact that the fan or blower is a non-deflected fan or blower to create a smooth continuous flow of air rather than bursts of air produced by many household fans.

The process of the present invention is the opposite of static electricity which creates a negative field which would repel the gold (and other metals with negative charges). The small and tiny gold particles are called “fine gold”. Apparently 98% of all the gold in the world is fine gold and normally not easy to separate from the earth material.

The process also cleans mercury out of the earth material and therefore has an environmentally beneficial use. Apparently many gold extricating processes use mercury which attracts the gold and then the mercury is burned leaving the gold, so many locations where gold was mined or where there was panning for gold have large amounts of pollution from the mercury.

The present invention is most useful for in surface mine-able ore, although the invention also is useful with gold ore that has been pulverized and put into tanks. The present invention makes surface mining of gold easier and more cost effective, thereby increasing the domestic gold reserve. By greatly reducing the costs of mining gold and by eliminating the environmental problems with the current technology, it now becomes more attractive and feasible to refine and finish gold domestically.

The present invention is directed to highly advanced industrial and hobby processes that will assist in cleaning biological waste such as liquid mercury used and in the grounds in any and all applications. This includes but not limits itself to gold fields and other areas all over the world. These procedures are still current and applications are using liquid mercury to extract gold from the dirt while the hazardous liquid mercury is lost in the dirt and rivers and lake and streams. While purification of fields from liquid mercury it will also recover fine gold, silver, platinum from its areas where hazardous liquid mercury was in the ground. The precipitate filter of the present invention can achieve gold silver and platinum recovery along with purifying the ground. The present invention is a breakthrough in gold, Silver and Platinum mining along with mercury extraction technology that eliminates substantial environmental problems extant with the current technology. The present invention uses only, a feeder with gravitations flowing gate system, distributed to the electro-dynamic charge trapping contributed to the invented filter and with no moving parts to achieve its success.

The present invention provides a safe alternative that has the positive result but at a significantly lower cost.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a side elevational view of the multi-layer filter system for mining fine particles of precious metals of the present invention showing the lower multi-layer filter and wind chamber and the upper hopper both supported by a set of legs;

FIG. 2 is a top plan view of the hopper of FIG. 1;

FIG. 3 is an end elevational view of the hopper of FIG. 1;

FIG. 4 is a side elevational view of the hopper of FIG. 1;

FIG. 5 is a perspective view of the hopper of FIG. 1 showing a metal mesh screen aligned for installation over the top fill opening of the hopper;

FIG. 6 is a top plan view of the wind chamber of FIG. 1;

FIG. 7 is an end elevational view of the wind chamber of FIG. 1;

FIG. 8 is a side elevational view of the wind chamber of FIG. 1;

FIG. 9 is a perspective view of the wind of FIG. 1 showing the baffle positioned above the blower opening;

FIG. 10 is an exploded perspective view of the components of the multi-layer filter of FIG. 1 aligned for assembly with the top and bottom frame structure and an optional dynamic filter dust shield on the top frame structure;

FIG. 11 is a perspective view of the components of the multi-layer filter of FIG. 1 assembled together with the top and bottom frame structure and an optional dynamic filter dust shield on the top frame structure;

FIG. 12 is a side elevational view of the components of the multi-layer filter of FIG. 1 assembled together with the top and bottom frame structure and an optional dynamic filter dust shield on the top frame structure;

FIG. 13 is a side cross-sectional view of the multi-layer filter system for mining fine particles of precious metals of FIG. 1 showing the lower multi-layer filter and wind chamber and the upper hopper and diagrammatically indicating the flow of the earth material and the wind.

### DETAILED DESCRIPTION OF THE INVENTION

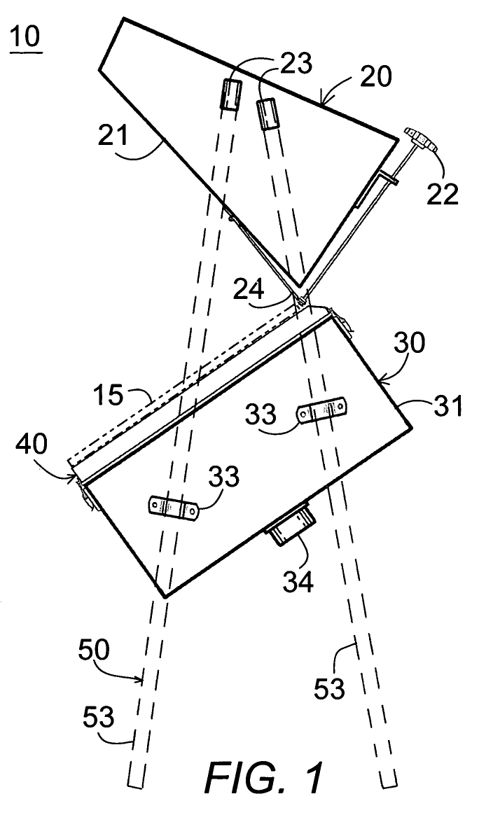

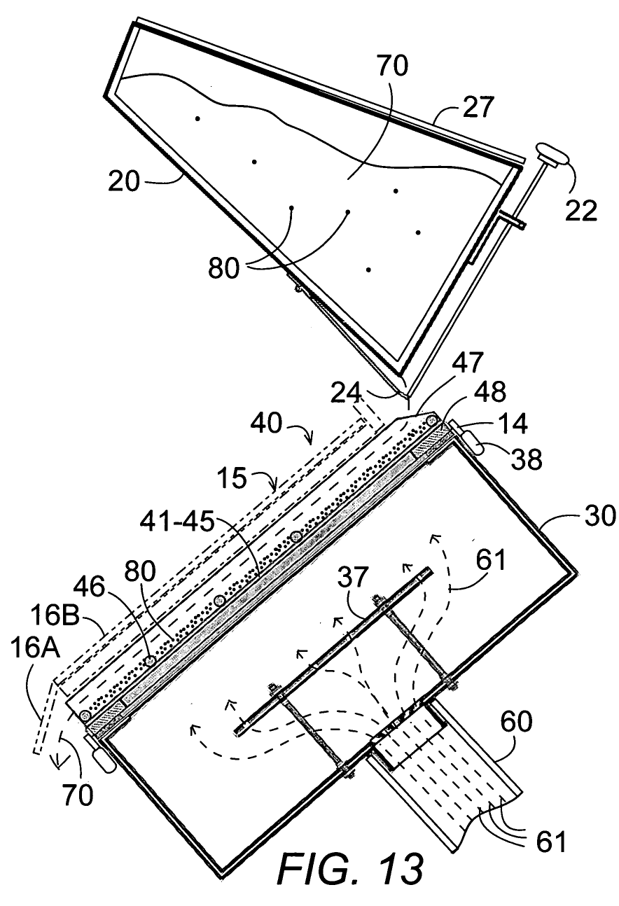

In FIGS. 1-13, a multi-layer filter system 10 for separating fine particles of precious metals 80 from earth material comprises a hopper 20 for pouring earth material 70 over a downwardly angled multi-layer filter structure 40 comprising a multi-layer filter 41-45 supported by a frame 47 and 48 on a wind chamber 30, as shown in FIG. 13, with both the wind chamber 30 and the hopper 20 supported by attached legs 53, as shown in FIG. 1.

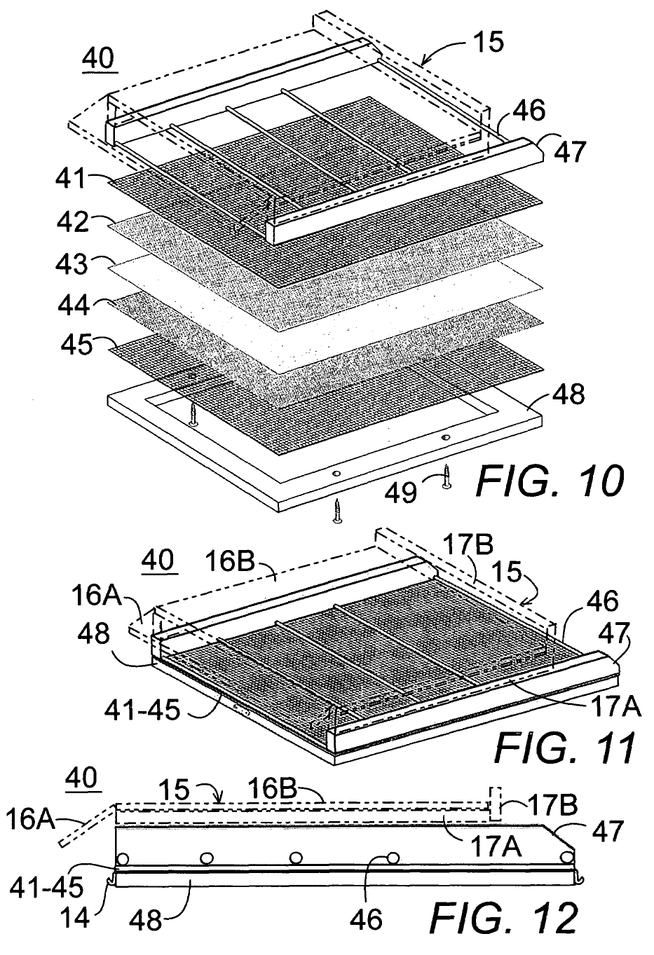

In FIGS. 10-12, the multi-layer filter structure 40 comprises a multi-layer filter having a bottom grid 45 of ¼ or ⅛ inch metal screen mesh on the bottom to act as a separator, the bottom grid 47 attached to a bottom frame section 48; a layer of burlap 44 on top of the mesh screen; a plastic polymer mesh 43 on top of the burlap with a vertically configured plastic mesh, such as in a shade screen material, to assist in causing a dynamic charge to attract fine particles of precious metals; a layer of fine mesh cotton fabric 42 (preferably 100% cotton) on top of the plastic polymer mesh to act as a holder while the top grid helps trap the gold and prevent it from rolling down with the earth material; and a top grid 41 of metal screen mesh on the top of the cotton fabric.

A two-piece filter frame 47 and 48 comprises a rigid top frame structure 47 with a central opening and a series of spaced filter rods 46 extending across the width of the top frame structure. The filter rods contact the top grid 41 and the top frame structure 47 contacts the edges of the multi-layer filter and extends upwardly from the multi-layer filter. The top frame structure 47 is formed of a rigid electrically insulating material, such as wood. The filter frame further comprises a bottom frame structure 48 below the bottom grid 45 of metal screen, the bottom frame structure screwed by screws 49 or other fasteners to the top frame structure sandwiching the multi-layer filter 41-45 therebetween.

In FIG. 10, the bottom rigid frame structure 48 comprises a rigid rectangular frame with an interior bottom frame opening to admit the air flow 61 from the wind chamber 30 up through the multi-layer filter 41-45, the outer edges of the rigid rectangular frame aligned with the outer edges of the multi-layer filter. The top rigid frame structure 47 comprises two rigid spaced parallel sides spanning a central opening and a series of spaced filter rods 46 interconnecting the two rigid spaced parallel sides, the outer edges of the two rigid spaced parallel sides aligned with the outer edges of two sides of the multi-layer filter, the two rigid spaced sides extending upwardly from the multi-layer filter to act as a guide-way for the earth material flowing 70 over the multi-layer filter 41-45, and the filter rods 46 contacting the top grid 41 of metal screen.

In FIGS. 10-13, an optional dynamic filter dust shield 15 is removably attachable to the top of the filter frame 47 spaced apart from the multi-layer filter 41-45 to increase the electro-dynamic charge and the amount of recovery of fine particles 80 of the at least one precious metal and to limit the amount of dust rising from the flow of earth material over the multi-layer filter. Two side shield frames 17A, in addition to the filter frame top structure 47, further elevate an acrylic or other synthetic sheet of non-breakable material 16B further above the multi-layer filter 41-45 to channel the flow of earth material 70 and prevent the rise of dust. A bottom angled extension 16A of the sheet of non-breakable material deflects the flow of earth material 70 downward. A vertical extension 17B of the shield frames further secures the sheet of non-breakable material 17B and helps to confine earth material 70 under the shield and prevent it from flowing over the shield.

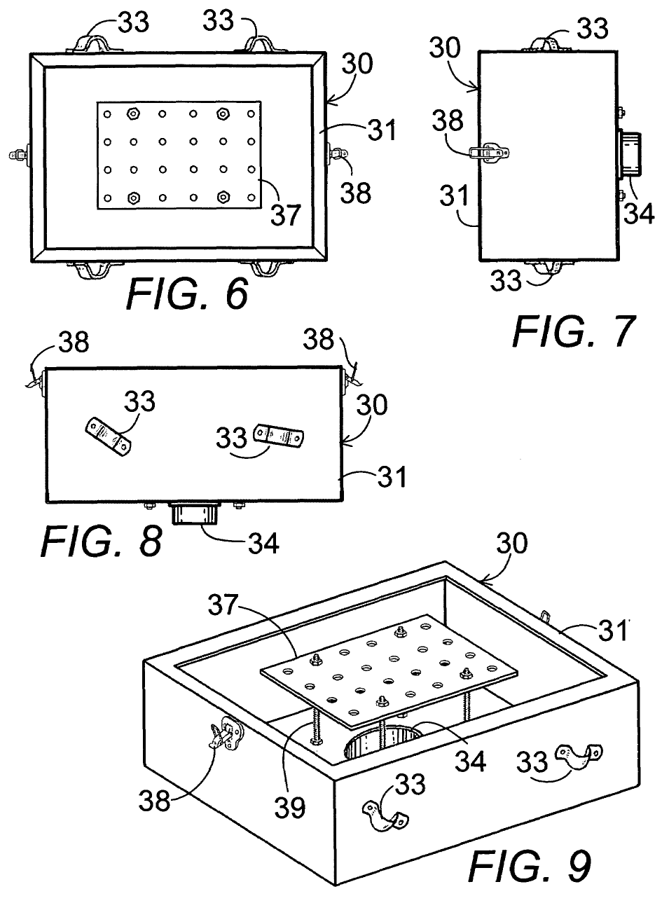

In FIGS. 6-9 and 13, a wind chamber 30 is positioned below the multi-layer filter 41-45 and comprises solid wind chamber walls 31 aligned with the filter frame 47 and 48 and removably attached to the bottom of the filter frame by a hook 14 and latch 38 or other releasable connecting means, a solid bottom attached to the bottom of the wind chamber walls with at least one blower opening having an attaching collar 34 means to attach a hose 60 from a non-deflected steady air stream fan or blower to admit a non-deflected steady stream of air 61 from the blower, which may be a leaf blower or other blower producing a steady stream of air. A baffle 37 with a grid of evenly spaced holes is positioned on legs 39 above the blower opening collar 34 and below the multi-layer filter 41-45 to distribute the steady flow of air 61 under and up through the entire surface of the multi-layer filter 41-45 over the entire surface of the multi-layer filter to create an electro-dynamic field in the multi-layer filter.

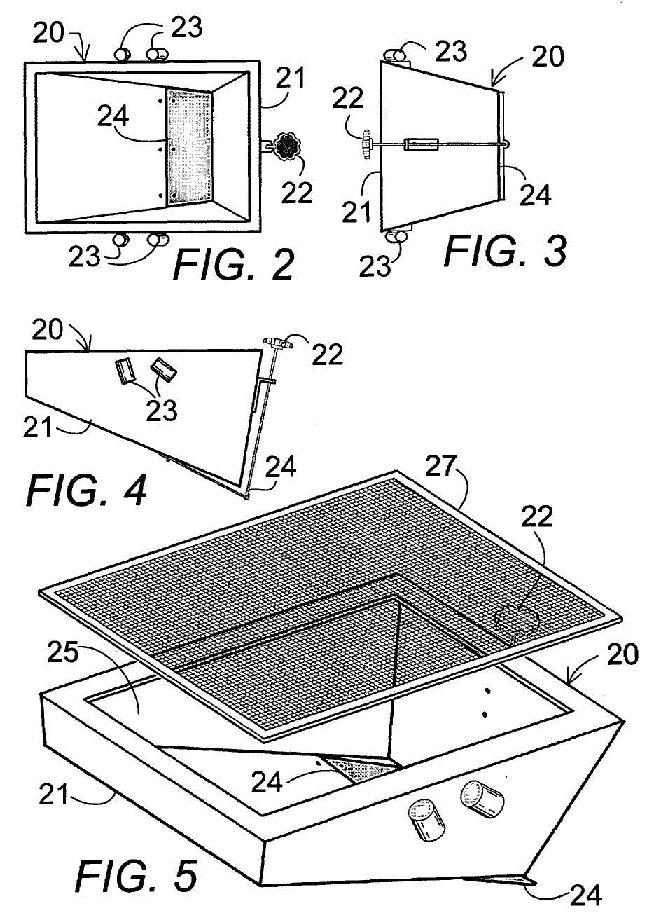

In FIGS. 2-5 and 13, a means for distributing a quantity of earth material 70 evenly across the top of the multi-layer filter 41-45 at a constant flow rate preferably comprises a hopper 20 positioned above the multi-layer filter 41-45 at a top end of the multi-layer filter with the multi-layered filter angled downwardly, as shown in FIG. 13, so that the earth material 70 flows downwardly over the multi-layer filter, as shown by the dashed line. The earth material 70 contains a dispersion of fine particles 80 of at least one precious metal, so that when the earth material 70 pours over the top of the multi-layer filter 41-45, the fine particles 80 of the at least one precious metal are attracted to the multi-layer filter 41-45, due to the fact that the fine particles 80 of the precious metal have an extra negative electron attracting them to the electro-dynamic field of the multi-layer filter while the remainder of the earth material 70 flows past the multi-layer filter.

The hopper 20 is equal in width to the multi-layer filter 41-45 and comprises a walled container 21 with closed sides, an open top to receive the earth material, and a bottom having a dispersing opening across the width of the hopper adjacent to one end of the hopper positioned above a top of the multi-layer filter with the bottom of the hopper angled downwardly toward the dispersing opening with a controlled weighing gate 24 across the width of the hopper over the dispersing opening. A shaft with a top knob control 22 is used for opening the controlled gate an adjustable amount to disperse a desired constant flow rate of a stream of the earth material 70 distributed evenly across the width of the top of the angled multi-layer filter 41-45 so the earth material 70 flows evenly down the entire surface of the multi-layer filter. In FIG. 5, a metal mesh screen 27 over the top opening of the hopper 20 screens the earth material to prevent large objects from entering the hopper.

In FIG. 1, a support system 50 comprises a series of support legs 53 for supporting the multi-layer filter 41-45, filter frame 47 and 48, and wind chamber 30 and for supporting the hopper 20 with the series of support legs 53 attached to both the wind chamber 30 by clamps 33 and the hopper 20 by sockets 23.

The two-piece filter frame 47 and 48 is preferably fabricated of wood. The layer of cotton 42 is preferably fabricated of 100% cotton. The bottom grid 45 and top grid 41 are preferably fabricated of ¼ inch or ⅛ inch metal screen mesh.

The system of claim 1 wherein the multi-layer filter attracts at least one of the following fine particles of the list of fine particles including fine particles of gold, silver, platinum, and liquid mercury.

In use, a multi-layer filter method for separating fine particles 80 of precious metals from earth material 70 comprises distributing a quantity of earth material 70 evenly across the top of the multi-layer filter system 41-45, having a non-deflected air 61 underflow means, at a constant flow rate by a means for distributing air flow, such as the baffle 37 positioned below the multi-layer filter 41-45 and a means for distributing earth material 70 at a top of the multi-layer filter with the multi-layered filter angled downwardly so that the earth material flows downwardly over the multi-layer filter 41-45, the earth material containing a dispersion of fine particles 80 of at least one precious metal, so that when the earth material 70 pours over the top of the multi-layer filter 41-45, the fine particles 80 of the at least one precious metal are attracted to the multi-layer filter 41-45, the fine particles of at least one precious metal having an extra negative electron attracting them to the electro-dynamic field of the multi-layer filter while the remainder of the earth material flows past the multi-layer filter;

The method is further enhanced by installing a dynamic filter dust shield 15 removably attachable to the top of the filter frame 47 spaced apart from the multi-layer filter 41-45 to increase the electro-dynamic charge and the amount of recovery of fine particles of the at least one precious metal and to limit the amount of dust rising from the flow of earth material over the multi-layer filter.

The step of distributing the quantity of earth material 70 evenly across the top of the multi-layer filter 41-45 comprises filling a hopper 20 with earth material 70 with the bottom of the hopper angled downwardly toward the dispersing opening with a controlled weighing gate 24 across the width of the hopper over the dispersing opening, and further comprises operating a control 22 for opening the controlled gate an adjustable amount to disperse a desired constant flow rate of a stream of the earth material 70 distributed evenly across the width of the top of the angled multi-layer filter 41-45 so the earth material flows evenly down the entire surface of the multi-layer filter. The method further comprises attaching a metal mesh screen 27 over the top opening of the hopper to screen the earth material to prevent large objects from entering the hopper.

The multi-layer filter 41-45 is used to attract at least one of the following fine particles of the list of fine particles including fine particles of gold, silver, platinum, and liquid mercury.

By definition fine gold is gold as small as 2 micron to 300 mesh per inch to 0.3 gram gold which are being trapped by the present invention. Visible gold larger than 0.3 gram may have also been trapped due to the spaced filter rods and electro-dynamic properties.

Based on the structure and functioning of the present invention and the liquidity of mercury, the electro-dynamic field of the present invention forces the liquid mercury to drop to the multi-layer filter with the electro-dynamic field while neutral earth material flows over the filter or rolls down the filter.

The air is preferably distributed under the multi-layer filter evenly at a ratio of approximately 170 cfm throughout the blower box containing the filter. The air passing under through the filter at the 170 cfm will develop a air mass that will allow the compound elements of material to flow inches above the filter while, fine gold, silver, platinum and liquid mercury are trapped and pulled to the grid. The cubic feet per inch will be dependant of the size of shape of the container box feeder box and filter as long as the rate is approximately 150 cfm to 200 cfm throughout the filter.

All earth material must be at least 90% dry to be able to separate from the fine particles of precious material and other non-desired material, such as mercury.

In the present invention, a small amount of all material will stay on the filter to be separated though the rate of 98% of the undesired material will be discharged.

It is understood that the preceding description is given merely by way of illustration and not in limitation of the invention and that various modifications may be made thereto without departing from the spirit of the invention as claimed.

What is claimed is:

1. A multi-layer filter precipitate system for separating fine particles of precious metals from earth material, the system comprising:
a multi-layer filter comprising:
a bottom grid of metal screen mesh on the bottom to act as a separator;
a layer of protective burlap fabric on top of the mesh screen;
a polymer non-conductive permeable screen mesh on top of the layer of burlap with a vertically configured plastic mesh to assist in causing a dynamic charge to attract fine particles of precious metals;
a layer of fine mesh cotton fabric on top of the plastic polymer mesh to act as a holder while the top grid helps trap the gold and prevent it from rolling down with the earth material; and
a top grid of metal screen mesh on the top of the cotton fabric;
a two-piece filter frame comprising a bottom rigid frame structure below the multi-layer filter and a top rigid frame structure above the multi-layer filter, the bottom and top rigid frame structures secured together to sandwich the multi-layer filter therebetween, the two-piece filter frame formed of rigid electrically insulating material;
a wind chamber positioned below the multi-layer filter and filter frame, the wind chamber comprising a means to receive a non-deflected steady stream of air into the wind chamber and a means to distribute the steady flow of air under and up through the entire surface of the multi-layer filter over the entire surface of the multi-layer filter to create an electro-dynamic field in the multi-layer filter; and
a means for distributing a quantity of earth material evenly across the top of the multi-layer filter at a constant flow rate, the means for distributing positioned above the multi-layer filter at a top of the multi-layer filter with the multi-layered filter angled downwardly so that the earth material flows downwardly over the multi-layer filter, the earth material containing a dispersion of fine particles of at least one precious metal, so that when the earth material pours over the top of the multi-layer filter, the electro-dynamic field of the multi-layer filter attracting fine particles of the at least one precious metal to the multi-layer filter, the fine particles of at least one precious metal having an extra negative electron attracting them to the electro-dynamic field of the multi-layer filter while the remainder of the earth material flows past the multi-layer filter.

2. The system of claim 1 wherein the wind chamber comprises solid wind chamber walls aligned with the filter frame and removably attached to the bottom of the filter frame, a solid wind chamber bottom attached to the bottom of the wind chamber walls, the means for receiving a non-deflected stead air stream comprising at least one blower opening in the wind chamber bottom having a means to attach a hose from a non-deflected steady air stream fan or blower to admit a non-deflected steady stream of air from the blower, and the means to distribute the steady flow of air under and up through the entire surface of the multi-layer filter over the entire surface of the multi-layer filter comprises a baffle positioned on legs above the blower opening and below the multi-layer filter.

3. The system of claim 1 further comprising a dynamic filter dust shield removably attachable to the top of the filter frame spaced apart from the multi-layer filter to increase the electro-dynamic charge and the amount of recovery of fine particles of the at least one precious metal and to limit the amount of dust rising from the flow of earth material over the multi-layer filter.

4. The system of claim 1 wherein the means for distributing the quantity of earth material evenly across the top of the multi-layer filter comprises a hopper equal in width to the multi-layer filter, the hopper positioned above the multi-layer filter, the hopper comprising a walled container with closed sides, an open top to receive the earth material, and a bottom having a dispersing opening across the width of the hopper adjacent to one end of the hopper positioned above a top of the multi-layer filter with the bottom of the hopper angled downwardly toward the dispersing opening, a controlled weighing gate across the width of the hopper over the dispersing opening, and a control for opening the controlled gate an adjustable amount to disperse a desired constant flow rate of a stream of the earth material distributed evenly across the width of the top of the angled multi-layer filter so the earth material flows evenly down the entire surface of the multi-layer filter.

5. The system of claim 4 further comprising a series of support legs for supporting the multi-layer filter, filter frame, and wind chamber and for supporting the hopper, the series of support legs attached to both the wind chamber and the hopper.

6. The system of claim 1 wherein the bottom rigid frame structure comprises a rigid rectangular frame with an interior bottom frame opening, the outer edges of the rigid rectangular frame aligned with the outer edges of the multi-layer filter; and the top rigid frame structure comprises two rigid spaced parallel sides spanning a central opening and a series of spaced filter rods interconnecting the two rigid spaced parallel sides, the outer edges of the two rigid spaced parallel sides aligned with the outer edges of two sides of the multi-layer filter, the two rigid spaced sides extending upwardly from the multi-layer filter to act as a guide-way for the earth material flowing over the multi-layer filter, and the filter rods contacting the top grid of metal screen.

7. The system of claim 1 wherein the filter frame is fabricated of wood.

8. The system of claim 1 wherein the layer of cotton is fabricated of 100% cotton.

9. The system of claim 1 wherein the bottom and top grids are fabricated of ¼ inch metal screen mesh.

10. The system of claim 1 wherein the bottom and top grids are fabricated of ⅛ inch metal screen mesh.

11. The system of claim 1 further comprising a metal mesh screen over the top opening of the hopper to screen the earth material to prevent large objects from entering the hopper.

12. The system of claim 1 wherein the multi-layer filter attracts at least one of the following fine particles of the list of fine particles including fine particles of gold, silver, platinum, and liquid mercury.

13. A multi-layer filter method for separating fine particles of precious metals from earth material, the method comprising:
distributing a quantity of earth material evenly across the top of the multi-layer filter system, having a non-deflected air underflow means, at a constant flow rate by a means for distributing air flow positioned below the multi-layer filter and a means for evenly distributing the earth material above the multi-layer filter at a top of the multi-layer filter with the multi-layered filter angled downwardly so that the earth material flows downwardly over the multi-layer filter, the earth material containing a dispersion of fine particles of at least one precious metal, so that when the earth material pours over the top of the multi-layer filter, the fine particles of the at least one precious metal are attracted to the multi-layer filter, the fine particles of at least one precious metal having an extra negative electron attracting them to the electro-dynamic field of the multi-layer filter while the remainder of the earth material flows past the multi-layer filter;
the multi-layer filter system comprising:
a multi-layer filter comprising:
a bottom grid of metal screen mesh on the bottom to act as a separator;
a layer of burlap on top of the mesh screen;
a plastic polymer mesh on top of the burlap with a vertically configured plastic mesh to assist in causing a dynamic charge to attract fine particles of precious metals;
a layer of fine mesh cotton fabric on top of the plastic polymer mesh to act as a holder while the top grid helps trap the gold and prevent it from rolling down with the earth material;
a top grid of metal screen mesh on the top of the cotton fabric;
a two-piece filter frame comprising a bottom rigid frame structure below the multi-layer filter and a top rigid frame structure above the multi-layer filter, the bottom and top rigid frame structures secured together to sandwich the multi-layer filter therebetween, the two-piece filter frame formed of rigid electrically insulating material;
a wind chamber positioned below the multi-layer filter and filter frame, the wind chamber comprising a means to receive a non-deflected steady stream of air into the wind chamber and a means to distribute the steady flow of air under and up through the entire surface of the multi-layer filter over the entire surface of the multi-layer filter to create an electro-dynamic field in the multi-layer filter.

14. The method of claim 13 further comprising installing a dynamic filter dust shield removably attachable to the top of the filter frame spaced apart from the multi-layer filter to increase the electro-dynamic charge and the amount of recovery of fine particles of the at least one precious metal and to limit the amount of dust rising from the flow of earth material over the multi-layer filter.

15. The method of claim 13 wherein the step of distributing the quantity of earth material evenly across the top of the multi-layer filter comprises filling a hopper with earth material, the hopper equal in width to the multi-layer filter, the hopper positioned above the multi-layer filter, the hopper comprising a walled container with closed sides, an open top to receive the earth material, and a bottom having a dispersing opening across the width of the hopper adjacent to one end of the hopper positioned above a top of the multi-layer filter with the bottom of the hopper angled downwardly toward the dispersing opening, a controlled weighing gate across the width of the hopper over the dispersing opening, and further comprises operating a control for opening the controlled gate an adjustable amount to disperse a desired constant flow rate of a stream of the earth material distributed evenly across the width of the top of the angled multi-layer filter so the earth material flows evenly down the entire surface of the multi-layer filter.

16. The method of claim 13 further comprising attaching a metal mesh screen over the top opening of the hopper to screen the earth material to prevent large objects from entering the hopper.

17. The method of claim 13 further comprising using the multi-layer filter to attract at least one of the following fine particles of the list of fine particles including fine particles of gold, silver, platinum, and liquid mercury.
